(19) United States
(12) Patent Application Publication
(10) Pub. No.: US 2023/0091721 A1
(43) Pub. Date: Mar. 23, 2023

(54) ANALYSIS SYSTEM, ANALYSIS METHOD, AND STORAGE MEDIUM

(71) Applicant: KABUSHIKI KAISHA TOSHIBA, Tokyo (JP)

(72) Inventors: Yusuke AOKI, Yokohama (JP); Yuki SAKURAI, Yokohama (JP)

(73) Assignee: KABUSHIKI KAISHA TOSHIBA, Tokyo (JP)

(21) Appl. No.: 17/653,722

(22) Filed: Mar. 7, 2022

(30) Foreign Application Priority Data
Sep. 21, 2021 (JP) 2021-153311

(51) Int. Cl. G06Q 10/06; G06V 20/52; G06V 40/20; H04N 7/18

(52) U.S. Cl. CPC G06Q 10/06398; G06V 20/52; G06V 40/20; H04N 7/183

(57) ABSTRACT

According to one embodiment, an analysis system includes a detector, a first determiner, a second determiner, and an output part. The detector detects a worker in an image of a work site, and calculates a position of the worker. The first determiner refers to layout data related to a layout of a plurality of work areas in the work site and determines a movement path of the worker in the layout based on the calculated position. The second determiner determines a work intensity of the worker from biological data of the worker. The output part outputs an analysis result of the layout, the movement path between the plurality of work areas, a movement frequency of the movement path, and the work intensity of the movement path.

### CROSS-REFERENCE TO RELATED APPLICATIONS

This application is based upon and claims the benefit of priority from Japanese Patent Application No. 2021-153311, filed on Sep. 21, 2021; the entire contents of which are incorporated herein by reference.

### FIELD

Embodiments described herein relate generally to an analysis system, an analysis method, and a storage medium.

### BACKGROUND

Efficiency and safety of a task are desirable. It is desirable to develop technology that can analyze the task from the perspective of efficiency and safety.

### BRIEF DESCRIPTION OF THE DRAWINGS

FIG. 1 is a schematic view showing a configuration of an analysis system according to an embodiment;

FIG. 2 is a schematic view showing layout data;

FIG. 3 is a schematic view showing an output example of the analysis result;

FIG. 4 is a flowchart showing an operation of the analysis system according to the embodiment;

FIG. 5 is a schematic view illustrating a work site;

FIG. 6A is a schematic view illustrating map data, FIG. 6B is a schematic view showing an image acquired by the imaging device;

FIG. 7A is a schematic view showing a cut-out image and extracted skeleton data, FIG. 7B is a schematic view showing a portion of the image from the imaging device;

FIG. 8 is a table showing the processing result of the detector;

FIG. 9 is a table showing the processing result of the first determiner;

FIGS. 10A to 10C are tables showing the processing result of the first determiner;

FIG. 11 is a table showing the processing result of the second determiner;

FIG. 12 is a table showing data combined by the second determiner;

FIGS. 13A, and 13B are schematic views showing output examples of analysis results;

FIGS. 14A, and 14B are schematic views showing output examples of analysis results;

FIG. 15 is a schematic view showing output example of analysis results; and

FIG. 16 is a schematic view showing a hardware configuration.

### DETAILED DESCRIPTION

According to one embodiment, an analysis system includes a detector, a first determiner, a second determiner, and an output part. The detector detects a worker in an image of a work site and calculates a position of the worker. The first determiner refers to layout data related to a layout of a plurality of work areas in the work site and determines a movement path of the worker in the layout based on the calculated position. The second determiner determines a work intensity of the worker from biological data of the worker. The output part outputs an analysis result. The analysis result is of the layout, the movement path between the plurality of work areas, a movement frequency of the movement path, and the work intensity of the movement path.

Various embodiments are described below with reference to the accompanying drawings.

In the specification and drawings, components similar to those described previously or illustrated in an antecedent drawing are marked with like reference numerals, and a detailed description is omitted as appropriate.

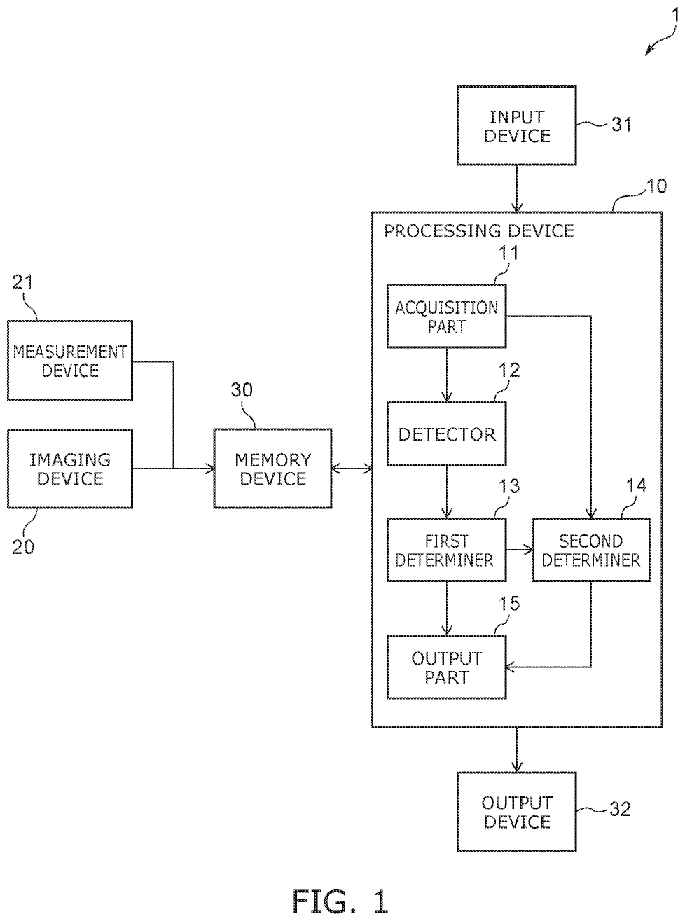

FIG. 1 is a schematic view showing a configuration of an analysis system according to an embodiment.

As shown in FIG. 1, the analysis system 1 according to the embodiment includes a processing device 10, an imaging device 20, a measurement device 21, a memory device 30, an input device 31, and an output device 32.

The processing device 10 analyzes the behavior and the work intensity of a worker in a work site. Specifically, the work site includes multiple work areas. The worker performs tasks in one of the multiple work areas. Also, the worker may move between the work areas between the tasks. The processing device 10 analyzes a movement path between the multiple work areas, a movement frequency of the movement path, the work intensity of the movement path, etc. The work intensity means the rigorousness of the task for the worker. As the work intensity increases, the load on the worker increases and the worker is caused to fatigue.

The imaging devices 20 acquires an image by imaging the worker. The imaging device 20 may be mounted at the multiple work areas and the paths between the multiple work areas. The imaging device 20 is, for example, a camera. The imaging device 20 acquires still images. The imaging device 20 may acquire a video image and cut out still images from the video image. The imaging device 20 stores the acquired data in the memory device 30.

The measurement device 21 acquires biological data of the worker. For example, the biological data is at least one selected from pulse rate, blood pressure, body motion, electrocardiographic potential, perspiration rate, body temperature, percutaneous arterial oxygen saturation (SpO₂), and breathing rate. The measurement device 21 is a wearable biological sensor that measures the biological data. The specific method for acquiring the biological data is arbitrary. For example, the measurement device 21 includes at least one selected from an acceleration sensor, a light-emitting device, a light-receiving device, a temperature sensor, a voltmeter, a humidity sensor, and a proximity sensor. The measurement device 21 acquires a measured value as biological data. The biological data may be calculated from the measured value. For example, at least one selected from a pulse wave sensor, a sphygmomanometer, a body motion sensor, an electrocardiograph, a perspiration sensor, a thermometer, a pulse oximeter, and a respirometer is used as the measurement device 21. The measurement device 21 stores the acquired biological data in the memory device 30.

The processing device 10 performs an analysis based on the images and the biological data. As shown in FIG. 1, the processing device 10 includes an acquisition part 11, a detector 12, a first determiner 13, a second determiner 14, and an output part 15.

The acquisition part 11 acquires the images and the biological data from the memory device 30. The acquisition part 11 may directly acquire the images and the biological data from the imaging device 20 and the measurement device 21.

The detector 12 detects the worker in an image of the worker. The detector 12 calculates the position of the detected worker. The detector 12 also may identify the detected worker.

The first determiner 13 refers to layout data. The layout data is related to the layout of multiple work areas.

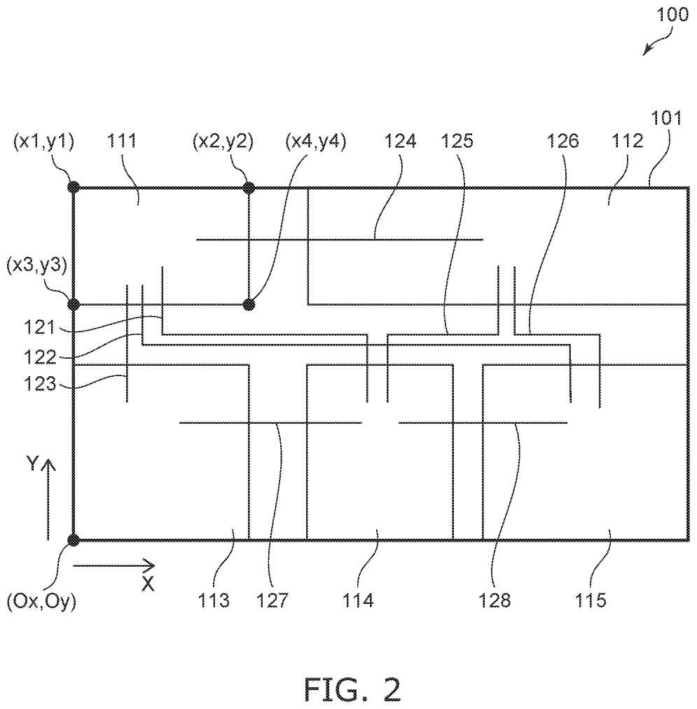

FIG. 2 is a schematic view showing layout data.

The layout data includes an image of the layout, the origin coordinate of the layout, the axis directions of the coordinate system, the coordinate of each work area, and the paths between the work areas. In the layout data 100 shown in FIG. 2, an image 101 is prepared, and the origin coordinate (Ox, Oy) and the axis directions (X, Y) are set. The work site also includes five work areas 111 to 115. The coordinates (x1, y1), (x2, y2), (x3, y3), and (x4, y4) of the four corners are set for each work area. Paths 121 to 128 along which the worker may move between the work areas 111 to 115 are set. Based on the calculated position, the first determiner 13 determines whether or not the movement path of the worker is one of multiple preset paths.

The second determiner 14 determines the work intensity of the worker based on the biological data. As an example, the biological data is the pulse rate. The second determiner 14 determines the work intensity by comparing the pulse rate to multiple thresholds. It is determined that the work intensity is higher as the pulse rate increases. The second determiner 14 may calculate the heart rate variability (the RR interval) from the pulse rate or the electrocardiographic potential. The heart rate variability corresponds to the stress level. The second determiner 14 determines the work intensity by comparing the heart rate variability to multiple preset thresholds. The second determiner 14 may determine the work intensity by comparing the body temperature or the perspiration rate to multiple thresholds. The body temperature or the perspiration rate corresponds to the risk of heatstroke. The second determiner 14 may determine the work intensity by comparing the blood pressure to multiple thresholds.

The thresholds for determining the work intensity may be common to multiple workers or may be set for each worker. It is favorable to set the thresholds based on the age of the worker or normal biological data of the worker.

The second determiner 14 may comprehensively determine the work intensity of the worker based on at least two sets of biological data. For example, the second determiner 14 calculates a normalized score based on each set of biological data. The second determiner 14 determines the work intensity by comparing the value obtained from the average, sum, weighted average, weighted sum, or the like of the scores to multiple thresholds.

The output part 15 uses the movement path determined by the first determiner 13 and the work intensity determined by the second determiner 14 to generate an analysis result, and outputs the analysis result to the output device 32.

The input device 31 is used when the user inputs data to the processing device 10. The input device 31 includes at least one selected from a mouse, a keyboard, a microphone, and a touchpad. The acquisition part 11 accepts the data input from the input device 31.

The output device 32 outputs the data so that the user can be aware of the data. The output device 32 includes at least one selected from a monitor, a projector, a printer, and a speaker. A device such as a touch panel that has the functions of both the input device 31 and the output device 32 may be used.

The processing device 10 includes a processing circuit that includes a central processing unit. The memory device 30 is a hard disk drive (HDD), a solid-state drive (SSD), a network HDD (NAS), etc. The processing device 10, the imaging device 20, the measurement device 21, the memory device 30, the input device 31, and the output device 32 are connected to each other by wireless communication or wired communication. The processing device 10, the memory device 30, the input device 31, and the output device 32 may be embedded in one device.

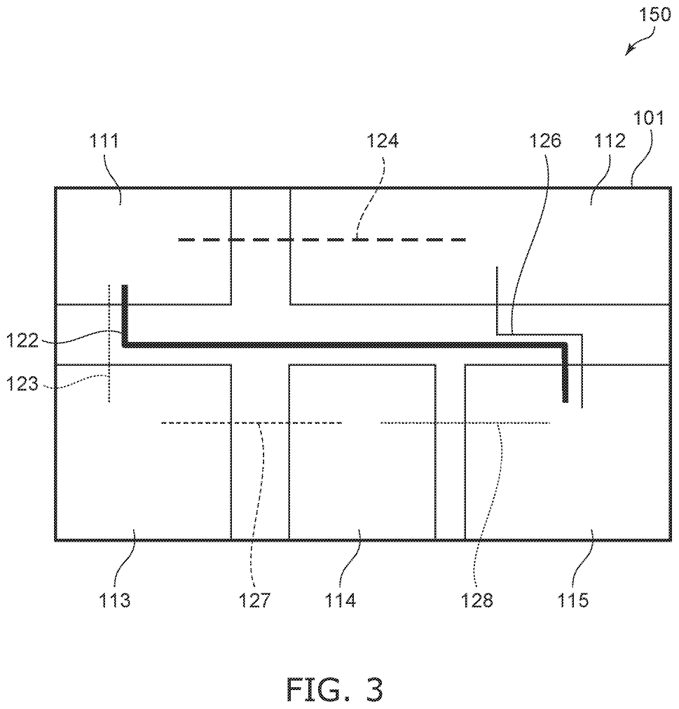

FIG. 3 is a schematic view showing an output example of the analysis result.

The analysis result 150 shows movement paths through which the worker moved, the movement frequencies, and the work intensities of the movement paths. For example, the analysis result 150 is output to a graphical user interface (GUI) displayed in the output device 32. In the example shown in FIG. 3, the displayed paths are movement paths of the worker. In other words, among the paths 121 to 128 shown in FIG. 2, the paths 122 to 124 and 126 to 128 are movement paths. The movement frequency is shown by the line thickness of the movement path. A thicker line shows that the movement frequency is high. In other words, compared to the paths of fine lines, the paths of thick lines show that the worker passes at a higher frequency. The type of the line shows the work intensity. In the example, the work intensity is shown based on the heart rate variability; and the work intensity corresponds to the stress level. A dotted line indicates that the stress level of the movement path is low. A dashed line indicates that the stress level of the movement path is about medium. A solid line indicates that the stress level of the movement path is large.

The movement path, the movement frequency, and the work intensity are displayed to overlap the image 101 of the layout. Thereby, the user can easily ascertain the movement path, the movement frequency, and the work intensity in the work site.

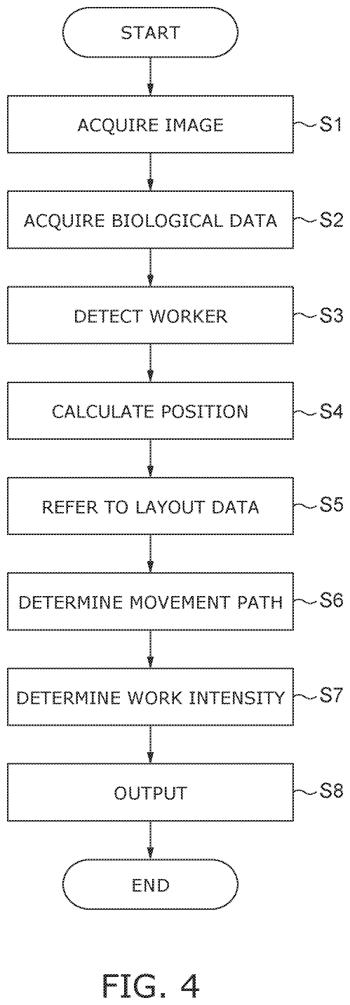

FIG. 4 is a flowchart showing an operation of the analysis system according to the embodiment.

The imaging device 20 acquires an image (step S1). The measurement device 21 acquires biological data of a worker (step S2). The detector 12 detects the worker in the image (step S3). The detector 12 calculates the position of the worker in the image (step S4). The first determiner 13 refers to layout data (step S5). The first determiner 13 determines the movement path of the worker based on the position of the worker (step S6). The second determiner 14 determines the work intensity of the worker based on the biological data (step S7). The output part 15 causes the output device 32 to output the analysis result of the layout, the movement path, the movement frequency, and the work intensity (step S8).

Advantages of the embodiment will now be described.

To realize an efficient task, it is favorable for the distance of a movement path of high movement frequency to be short. For example, by arranging two work areas of high movement frequency to be proximate to each other, the time necessary to move between the work areas can be reduced, and the work efficiency can be increased.

On the other hand, from the perspective of the safety of the tasks, it is favorable to consider the work intensity of the movement path. For example, even if the movement frequency of a long movement path is low, the safety may have room for improvement if heavy components, partly-finished workpieces, etc., are transported along the movement path or if a transportation method that puts a large load on the worker is used along the movement path. Over-fatigue of the worker may cause nonoptimal vitality and a reduction of the efficiency of the tasks.

For this problem, the analysis system 1 according to the embodiment determines the movement path of the worker and determines the work intensity of the worker based on the biological data of the worker. Then, as shown in FIG. 3, the analysis system 1 outputs the layout and the analysis result that shows the movement paths between the multiple work areas, the movement frequencies of the movement paths, and the work intensities of the movement paths. By referring to the analysis result, the user can easily ascertain the movement paths and the movement frequencies as well as the work intensities of the movement paths. For example, by taking into account the analysis result, the user can design the layout so that the work areas of high movement frequency can approach each other without the distances of movement paths in which the load on the worker is the large being excessively long.

According to the embodiment, the task can be analyzed from the perspective of efficiency and safety. The invention according to the embodiment may be favorably used to analyze a task that includes frequent movement such as in a construction site, when marshaling in a work site, etc. The application of the invention according to the embodiment to such tasks enables visibility of accident risks, the setting of appropriate break times, the suppression of occupational accidents, etc.

Processing according to the processing device 10 will now be described while referring to specific examples.

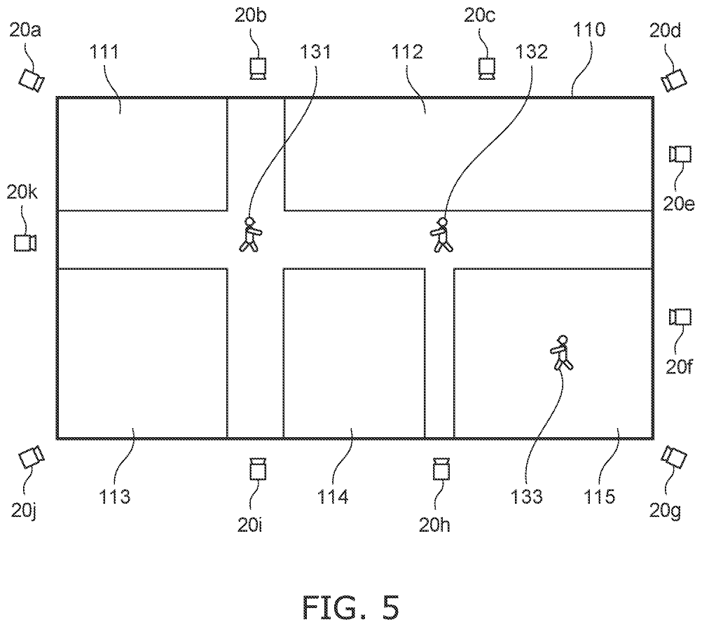

FIG. 5 is a schematic view illustrating a work site.

For example, as shown in FIG. 5, multiple imaging devices 20a to 20k are located in a work site 110. Multiple workers 131 to 133 perform tasks in the work site 110.

### Detector

The detector 12 refers to a first model for detecting a worker in an image. The first model is prepared by the user beforehand and is stored in the memory device 30. The first model includes a neural network. It is favorable for the first model to include a convolutional neural network (CNN). By using a CNN, the worker can be detected with high accuracy in the image. The first model is pretrained to detect a worker in an image. The detector 12 may detect the worker in the image by using Single Shot MultiBox Detector (SSD) or Regions with CNN (R-CNN).

The detector 12 inputs the image to the first model and detects the worker included in the image. The detector 12 uses the detection result to cut out a portion of the image of the worker. For example, a rectangular portion of the image is cut out. The images of the worker that are cut out from each image are stored in the memory device 30 by the detector 12. Also, the position from which the worker is cut out in each image is stored by the detector 12 in the memory device 30 as a detection region.

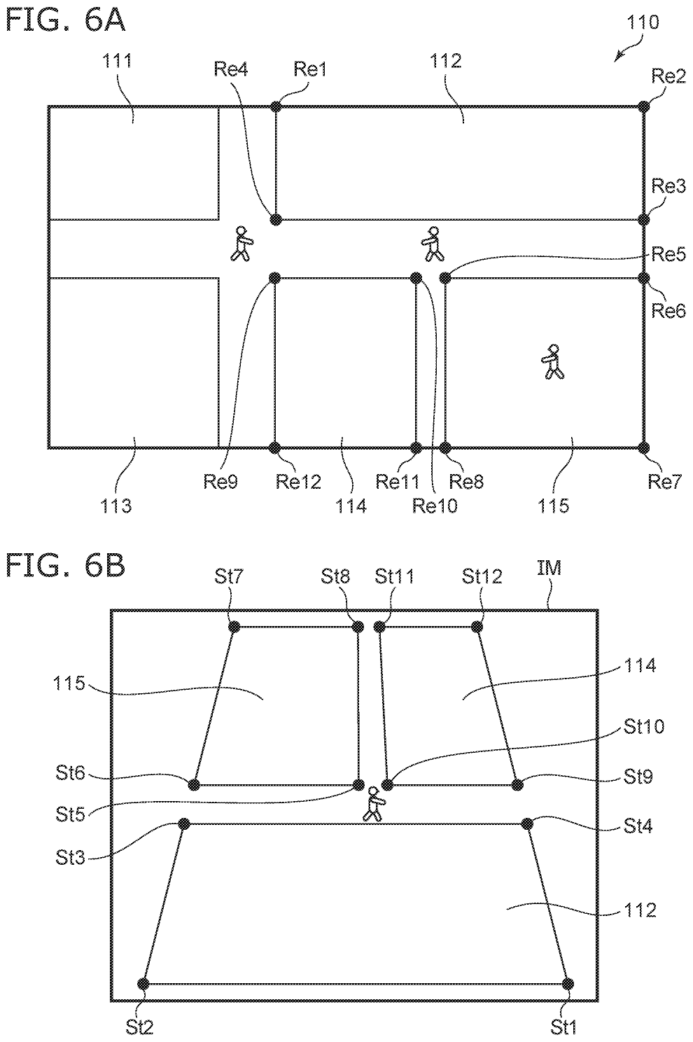

FIG. 6A is a schematic view illustrating map data. FIG. 6B is a schematic view showing an image acquired by the imaging device.

The detector 12 refers to the map data represented using a two-dimensional coordinate system that is prestored in the memory device 30. Multiple reference points are preset in the map data. Multiple control points are preset in the image acquired by the imaging device 20. For example, as shown in FIG. 6A, multiple reference points Re1 to Re12 are set in map data M in the area imaged by the imaging device 20c. As shown in FIG. 6B, multiple control points St1 to St12 are set in an image IM that is imaged by the imaging device 20c.

The multiple control points in the image are set to positions that correspond to the multiple reference points of the map data. The detector 12 converts the coordinate system of the image so that the multiple control points and the multiple reference points respectively match. A perspective projection transformation matrix can be used in the conversion. In the example of FIGS. 6A and 6B, the coordinate system is converted so that the coordinates of the multiple control points St1 to St12 match the coordinates of the multiple reference points Re1 to Re12. Multiple reference points may be commonly set in the map data for the multiple imaging devices 20, or multiple reference points may be set for each of the imaging devices 20.

The detector 12 calculates the position of the worker in the image by using the grounded part of the worker on the floor surface as a reference. For example, the detector 12 uses the position of the center of the bottom side of the detection region as the position of the worker in the image. The position of the worker in the common coordinate system is calculated by the coordinate system conversion described above.

The detector 12 may identify the worker. A second model for identifying the worker in the image is prestored in the memory device 30. The second model includes, for example, a neural network. Favorably, the second model includes a CNN. By using a CNN, the worker can be identified with high accuracy. The second model is pretrained to be able to identify the worker. Or, the detector 12 may identify the worker by extracting histograms of oriented gradients (HOG) features from the image and inputting the HOG features to a support vector machine (SVM).

After cutting out the region in which the worker is detected from the image acquired by the imaging device 20, the detector 12 inputs the cut-out image to the second model. The detector 12 identifies the worker included in the image to be the worker corresponding to the class that obtained the highest confidence level. The detector 12 stores the identification result of the worker and the confidence level in the memory device 30.

The worker may wear a marker to make the identification by the detector 12 easy. The second model may identify the worker by identifying the marker. For example, when the worker wears a vest, the second model may identify the color of the vest, a printed character, etc. The detector 12 stores the identification result of the marker in the memory device 30 as the identification result of the worker.

Portions of the areas imaged by at least two of the imaging devices 20 may overlap each other. When the same worker is visible in multiple images at the same time, the detector 12 calculates the positions of the worker in the images and converts the positions into positions in the common coordinate system. The “same time” includes not only cases where two or more times exactly match but also cases where the difference between the two or more times is small. For example, two or more times can be considered to be substantially the same if the difference between the times are within 5 seconds. For example, the detector 12 calculates the middle between the positions in the common coordinate system as the position of the worker.

When calculating the position of the worker in the image, the detector 12 may calculate the certainty of the position. The detector 12 uses the certainty of each position to calculate the position of the worker. For example, a higher certainty means that the accuracy of the position is higher. It is favorable for the certainty to be calculated using at least one of the following five values.

The first value is the confidence level of the identification result of the person. A higher confidence level means that the identification result of the person is more accurate. In other words, the person is more clearly visible in the image. The certainty is calculated to be higher as the confidence level increases.

The second value is the size of the worker in the image. In other words, this is the size of the detection region. The worker appears larger as the worker becomes proximate to the imaging device 20. The accuracy of the position increases as the worker appears larger. Accordingly, the certainty is calculated to be higher as the size increases.

The third value is the distance between the worker and the center of the image. For example, the detector 12 calculates the distance between the center of the image and the center of the detection region. The likelihood of the worker being partially cut off from the image decreases as the distance decreases. The accuracy of the position increases as the fraction of the worker that is partially cut off decreases. Accordingly, the certainty is calculated to be higher as the distance decreases.

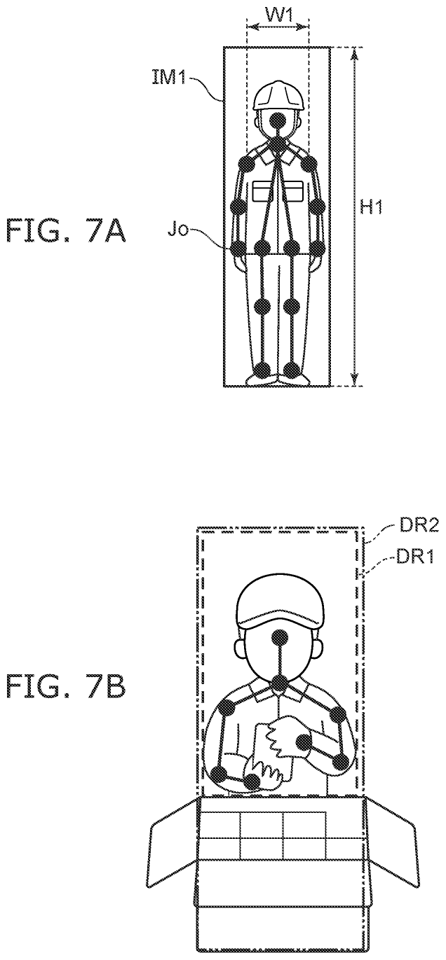

FIG. 7A is a schematic view showing a cut-out image and extracted skeleton data. FIG. 7B is a schematic view showing a portion of the image from the imaging device.

The fourth value is a value that indicates the pose of the person. The detector 12 extracts skeleton data of the person from the cut-out image. For example, as shown in FIG. 7A, multiple joints Jo are extracted from a cut-out image IM1 as skeleton data. The detector 12 calculates a width W1 between the two shoulders. The detector 12 calculates a ratio R1 of the width W1 to a height H1 of the cut-out image. For example, a ratio R2 of a shoulder width W2 to a body height H2 when each person faces the front is prestored in the memory device 30. The detector 12 uses a ratio R3 of the ratio R1 to the ratio R2 as the value indicating the pose of the person. A large ratio R3 means that the person faces the front or the back in the image. As the person faces the front or the back, the likelihood of two hands and two feet of the person being visible increases, and the accuracy of the detection of the worker increases. Accordingly, the certainty is calculated to be higher as the ratio R3 increases.

The fifth value is the exposure degree of the worker in the image. For example, as shown in FIG. 7B, a portion of the worker is hidden in the image. In such a case, the region in which the worker is visible is detected as a detection region DR1. The detector 12 extracts the skeleton positions of the person visible in the detection region DR1 and estimates the positions of the skeleton that are hidden.

For example, a model for estimating the positions of the skeleton of the person and estimating the association of the joints based on the image is prestored in the memory device 30. OpenPose can be used as the model. The detector 12 uses the model to estimate the skeleton positions of the person including hidden skeletal parts. The detector 12 corrects the detection region based on the estimation result. A corrected detection region DR2 is the region where the person is estimated to be visible when there is no light-shielding object.

The detector 12 calculates the ratio of the surface area of the detection region DR1 to the surface area of the corrected detection region DR2 as the exposure degree. A higher exposure degree means that many parts of the worker are visible. The accuracy of the detection of the worker increases as the exposure degree increases. Accordingly, the certainty is calculated to be higher as the exposure degree increases.

The detector 12 calculates the certainty by using at least one of the five values described above. Favorably, the detector 12 calculates the certainty by using all of the five values. For example, the detector 12 uses the average of the five values as the certainty. Or, weights may be preset for the five values by considering the priorities of these values. The detector 12 may multiply each value by its weight and use the sum of the products as the certainty. The detector 12 calculates the certainty for each position.

The detector 12 calculates the combined position by using the multiple positions and the certainties of the positions. For example, the detector 12 uses the certainty as a weight. The detector 12 normalizes the multiple certainties and multiplies the positions by their certainties. The detector 12 calculates the sum of the products as the combined position. By using the certainties, the position of the worker can be calculated with higher accuracy.

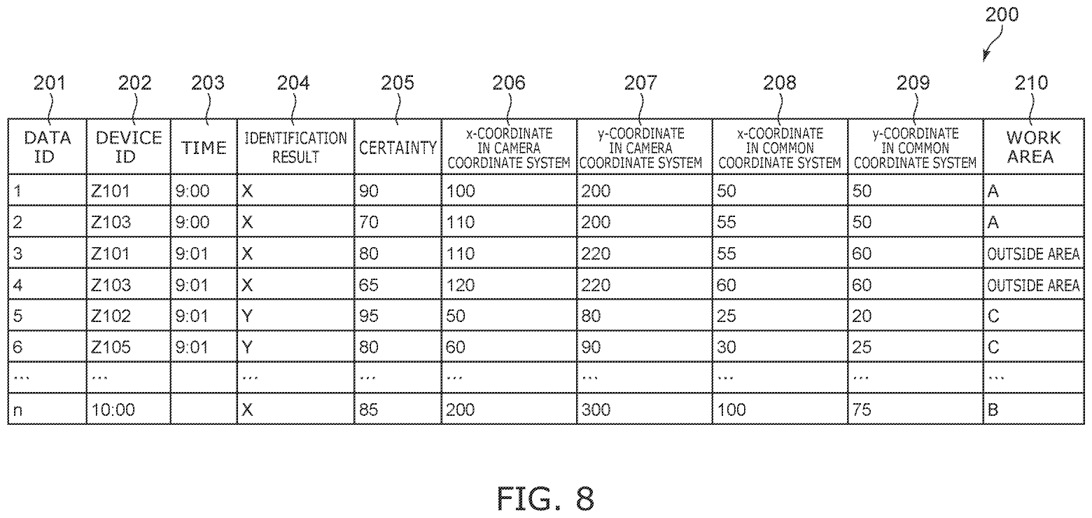

FIG. 8 is a table showing the processing result of the detector.

The table 200 shown in FIG. 8 includes a data ID 201, the device ID 202, a time 203, an identification result 204, a certainty 205, an x-coordinate 206 in the camera coordinate system, a y-coordinate 207 in the camera coordinate system, an x-coordinate 208 in the common coordinate system, a y-coordinate 209 in the common coordinate system, and a work area 210.

The data ID 201 is a unique character string assigned to the data obtained from the processing of one image. The device ID 202 is a unique character string assigned to each of the imaging devices 20. The time 203 is the time of the imaging. The identification result 204 is the identification result of the worker detected in the image. For example, an ID, a name, or the like for identifying the worker is recorded as the identification result. The certainty 205 is the certainty of the coordinate. The x-coordinate 206 and the y-coordinate 207 are respectively the positions in an X-direction and a Y-direction of the worker in the image. The x-coordinate 208 and the y-coordinate 209 are obtained by respectively converting the x-coordinate 206 and the y-coordinate 207 into the common coordinate system. The work area 210 is the work area where the worker is; and the x-coordinate 208 and the y-coordinate 209 are derived by comparing to the layout data. “Outside the area” means that the worker is not in any of the work areas and is moving along a path. As described above, two or more positions calculated for two or more images obtained at the same time are combined as appropriate for the x-coordinate 208 and the y-coordinate 209.

The first determiner 13 determines the movement path of the worker from the processing result of the detector 12. First, the first determiner 13 subdivides the processing result for each worker and rearranges the subdivided data in chronological order. For the data at each time, the first determiner 13 refers to the work area of the directly-previous data. When the work area of the directly-previous data is “outside the area”, the last work area that the worker was in is used as the directly-previous work area. When the current work area has not changed from the directly-previous work area in the data of each time, the first determiner 13 determines that the worker has not moved from the directly-previous work area. When the current work area has changed from the directly-previous work area in the data of each time, the first determiner 13 determines that the worker has moved from the directly-previous work area to the current work area. The first determiner 13 determines the existence or absence of the movement and the movement path for each worker.

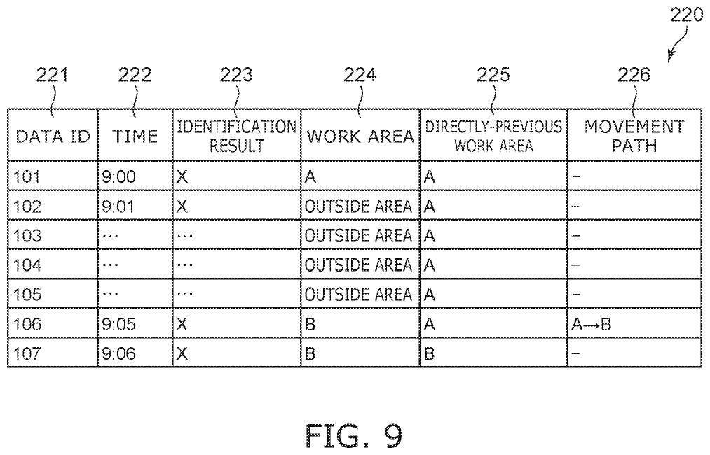

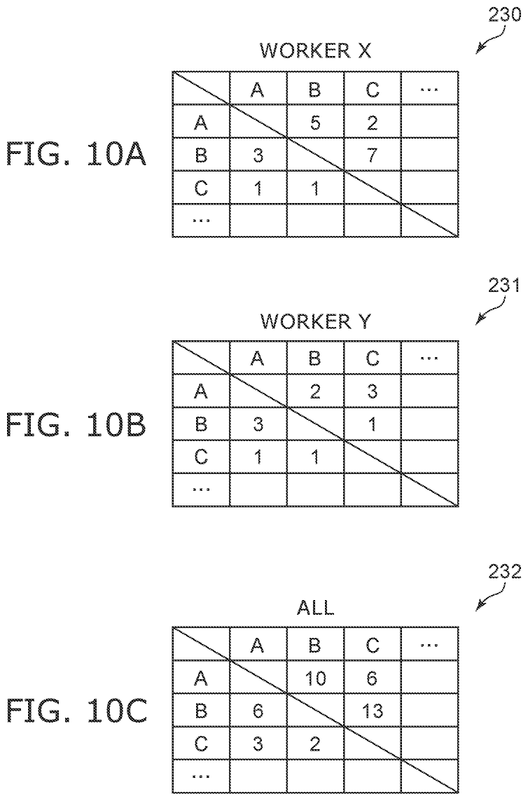

FIG. 9 and FIGS. 10A to 10C are tables showing the processing result of the first determiner.

A table 220 shown in FIG. 9 shows the extraction results of data related to a worker X. The table 220 includes a data ID 221, a time 222, an identification result 223, a work area 224, a directly-previous work area 225, and a movement path 226.

FIG. 9 shows the extraction result from data that includes combined positions of the worker calculated from images of the same time. The data ID 221 is a unique character string assigned to the data after the positions are combined. The time 222 is a time that corresponds to the position after combining. Similarly to the identification result 204, the identification result 223 is the identification result of the worker detected in the image. The work area 224 is the work area that corresponds to the position after combining. The directly-previous work area 225 is the directly-previous work area for each time. The movement path 226 is the existence or absence of the movement and the path.

For example, as shown in FIGS. 10A to 10C, the first determiner 13 generates from-to charts 230 to 232 from the determination results of the movement paths. In the from-to charts 230 to 232, each row is the work area of the origin. Each column is the work area of the destination. The values of the cells show the number of movements (the movement frequency) of the paths. The from-to charts 230 and 231 show the movement paths and the movement frequencies respectively of the workers X and Y. The from-to chart 232 shows the movement paths and the movement frequencies of all of the workers.

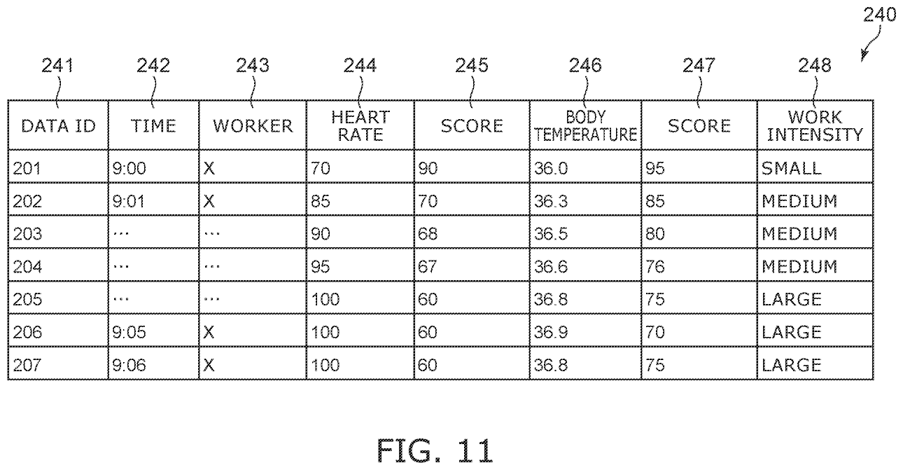

FIG. 11 is a table showing the processing result of the second determiner.

The table 240 shown in FIG. 11 includes a data ID 241, a time 242, a worker 243, first biological data 244, a score 245, second biological data 246, a score 247, and a work intensity 248.

The data ID 241 is a unique character string assigned to the biological data and the determination result of the work intensity obtained at each time. The time 242 is the time at which the biological data is obtained. The worker 243 is the worker to which the measurement device 21 is mounted. The first biological data 244 and the second biological data 246 are biological data obtained by the measurement device 21. The first biological data 244 and the second biological data 246 may be obtained by one measurement device 21 or may be obtained by separate measurement devices 21. The scores 245 and 247 are evaluations respectively of the first and second biological data 244 and 246 from the perspective of the work intensity. The work intensity 248 is the work intensity determined based on the scores 245 and 247. The score 245, the score 247, and the work intensity 248 are calculated by the second determiner 14.

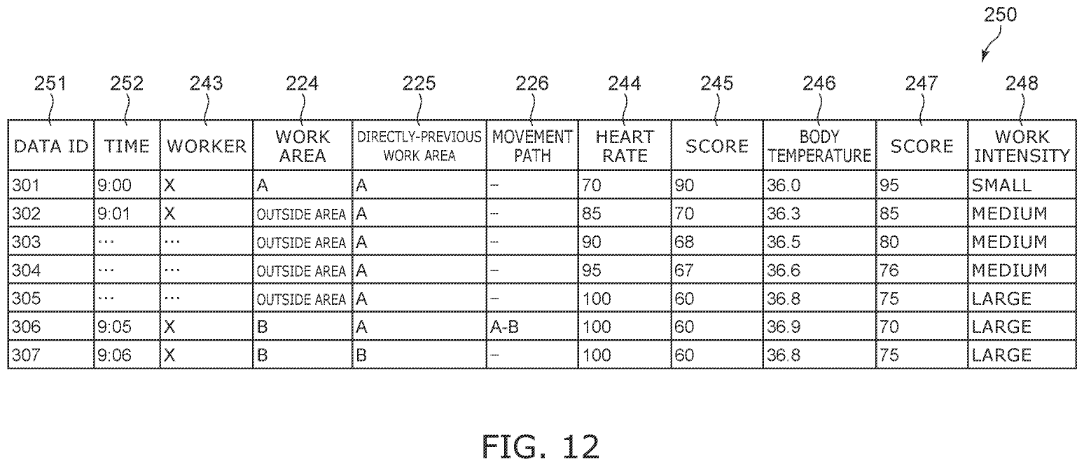

FIG. 12 is a table showing data combined by the second determiner.

The second determiner 14 combines the data of the table 220 and the data of the table 240 from the first determiner 13. Specifically, the second determiner 14 searches for matching data of the time and the worker (the identification result) between the tables 220 and 240 and combines such data. As shown in FIG. 12, a combined table 250 that is obtained by the combining includes a data ID 251, a time 252, the worker 243, the work area 224, the directly-previous work area 225, the movement path 226, the first biological data 244, the score 245, the second biological data 246, the score 247, and the work intensity 248.

The output part 15 generates an analysis result based on the from-to chart generated by the first determiner 13 and the combined table of the second determiner 14. The movement paths between the multiple work areas and the movement frequencies of the movement paths in the analysis result are shown in the from-to chart. The work intensity of the movement path is determined from the combined table of the second determiner 14. For example, the temporal average of the scores based on the biological data is calculated for the data that is determined to be “outside the area” between the work area of the origin and the work area of the destination. The work intensity of the movement path is determined by comparing the calculated average value to multiple thresholds. The output part 15 outputs the generated analysis result as shown in FIG. 3.

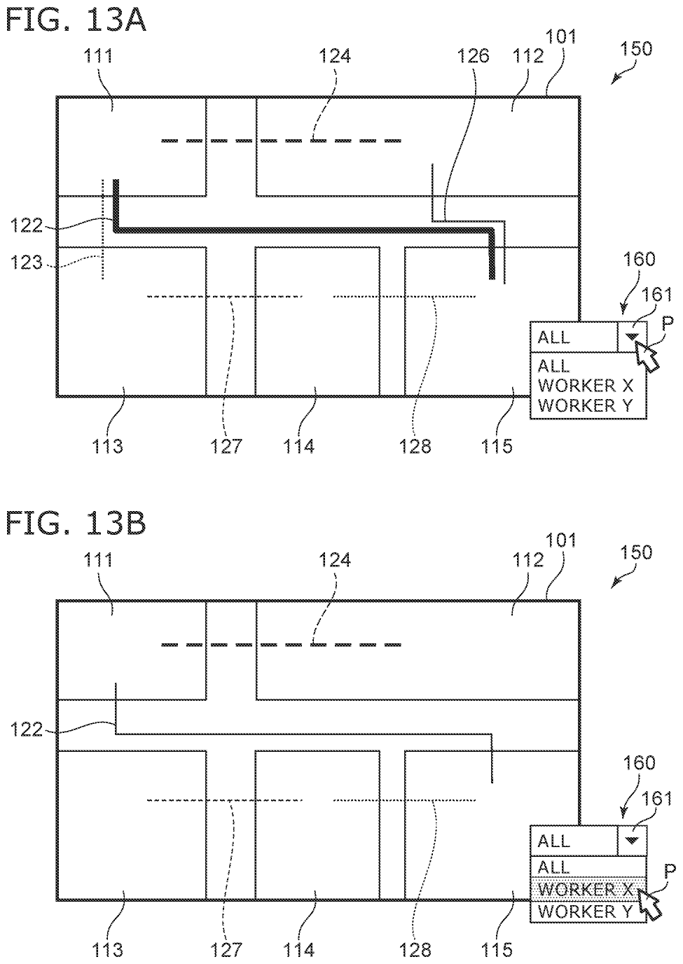

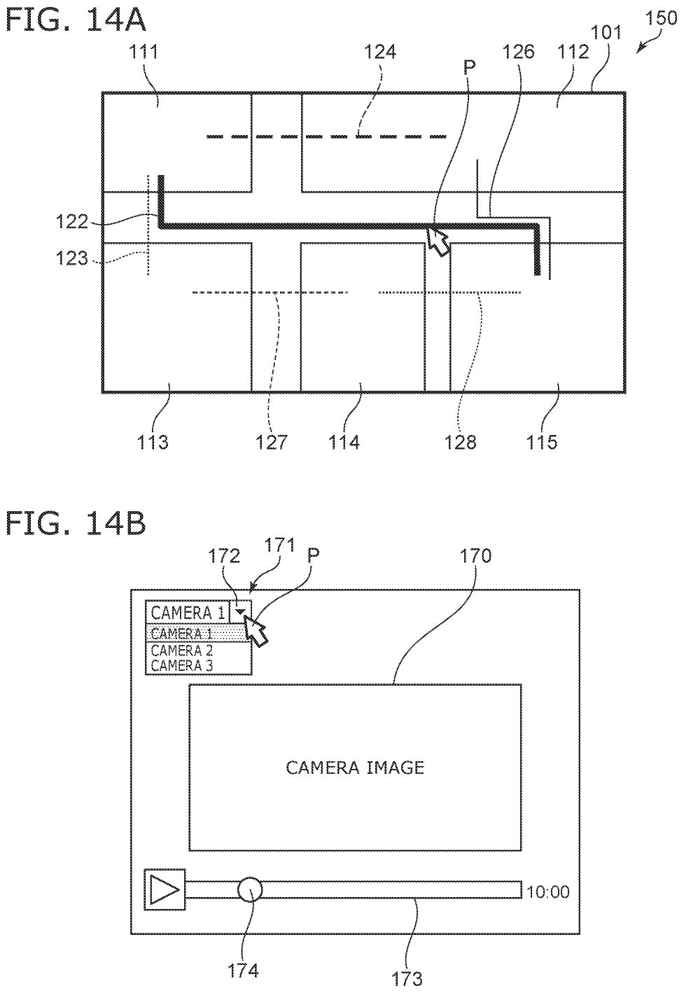

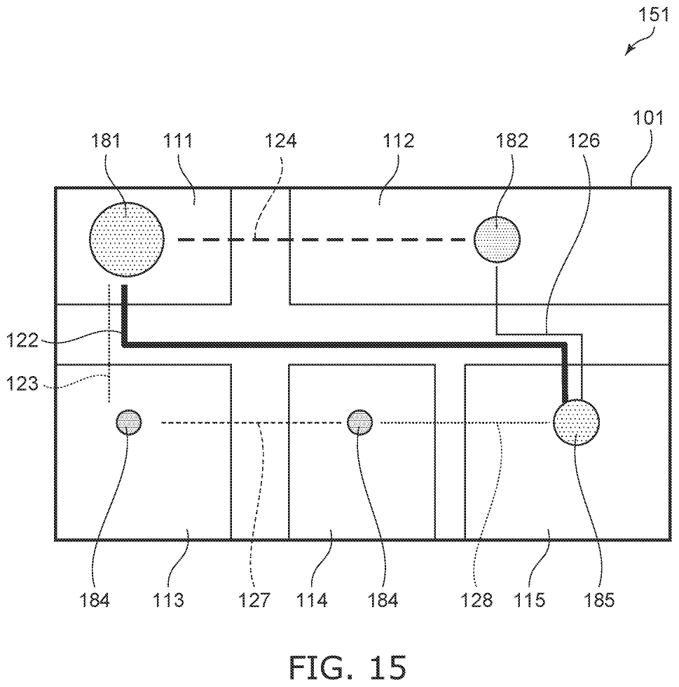

FIG. 13A, FIG. 13B, FIG. 14A, FIG. 14B, and FIG. 15 are schematic views showing output examples of analysis results.

When the analysis of multiple workers is performed, the analysis result may include the overall analysis result and the individual analysis result. The output part 15 can switch between the display of the overall analysis result and the display of the individual analysis result. The overall analysis result shows the multiple movement paths, the movement frequencies of the movement paths, and the multiple work intensities related to the multiple workers. The individual analysis result shows at least one of the multiple movement paths, the movement frequency of at least one of the multiple movement paths, and at least one of the multiple work intensities related to one of the multiple workers.

For example, the processing device 10 accepts, from the user, a selection of a worker to be analyzed in a GUI displaying the analysis result 150. As shown in FIG. 13A, the analysis result 150 includes a pull-down menu 160. The user moves a pointer P by operating the input device 31. When an icon 161 is clicked, a list of the workers is displayed. The user can select the worker to be analyzed by moving the pointer P. When the worker is selected, the output part 15 extracts data related to the selected worker from the from-to chart and the combined table. Based on the extracted data, for example, as shown in FIG. 13B, the output part 15 outputs the analysis result of the movement paths, the movement frequencies, and the work intensities of the movement paths for only the selected worker.

Because the overall analysis result and the individual analysis result are displayed, the user can evaluate the layout from both the perspective of the entire task and the perspective of the individual worker. For example, the user can check whether or not the layout is appropriate for the tasks as an entirety, and can check whether or not a large load is applied to a specific worker.

The processing device 10 may accept the selection of the movement path from the user in a GUI that displays the analysis result 150. For example, as shown in FIG. 14A, the user overlays and clicks the pointer P on one of the movement paths. When the movement path is selected as shown in FIG. 14B, an image 170 is displayed, and is obtained by the imaging device 20 that includes the path in its imaging area. A pull-down menu 171 is displayed when the selected path is imaged by multiple imaging devices 20. A list of the imaging devices 20 is displayed when an icon 172 is clicked. The user can select one of the imaging devices 20 by moving the pointer P. When one of the imaging devices 20 is selected, the output part 15 displays the image acquired by the selected imaging device 20.

In the example shown in FIG. 14B, the imaging device 20 acquires a video image; and the video image of the selected path is displayed. In such a case, a bar 173 and a slider 174 may be displayed. The user can designate a portion of the displayed video image by moving the slider 174.

The second determiner 14 may process the biological data to determine only the effects of the movement path on the work intensity. For example, as shown in FIG. 12, the measurement device 21 acquires the biological data of the worker when working and when moving in the work area. The second determiner 14 calculates the difference between the biological data when moving and the biological data when working. The change of the biological data due to the movement itself is calculated thereby. The second determiner 14 determines the work intensity of the movement path based on the difference. For example, the second determiner 14 determines the stress level due to the movement by comparing the change of the heart rate variability due to the movement to multiple preset thresholds. The second determiner 14 may determine the heatstroke risk due to the movement based on the change of the body temperature or the perspiration rate due to the movement.

If the difference described above is not used, the work intensity of the worker due to a movement performed after a task having a large load may be determined to be large even when the load of the movement itself is small. It is not always necessary to reduce the distance of a movement path when, for example, the fatigue due to the movement is sufficiently small and the safety when moving is high. By determining only the work intensity due to the movement by using the difference described above, an analysis result that is more useful for designing the layout can be obtained.

The output part 15 also may include the work intensity of the worker in each work area in the analysis result.

For example, in an analysis result 151 shown in FIG. 15, marks 181 to 185 are displayed in each of the multiple work areas 111 to 115. The size (the diameter) of the mark shows the dwell time in that work area. The color (the density of the dots) of the mark shows the work intensity in the work area. In the example of FIG. 15, the work intensity is lower as the density of the dots decreases.

The second determiner 14 may process the biological data to determine only the effects on the work intensity for the entire task. For example, the measurement device 21 acquires the biological data of the worker before the task start and after the task start. The biological data before the task start may be input by the user. The second determiner 14 calculates the difference from the biological data before the task start for each set of biological data obtained after the task start. The change of the biological data due to the task itself is calculated thereby. Based on the difference, the second determiner 14 determines the work intensity when working and when moving after the task start. Only the work intensity due to the task can be determined thereby.

The second determiner 14 may process the biological data to determine only the effects of an individual task on the work intensity. For example, the second determiner 14 calculates the difference between the biological data at the task start in one work area and the biological data at the task end in the one work area. The second determiner 14 considers the time directly after the movement to be the task start, and considers the time directly before the next movement to be the task end. The change of the biological data due to the individual task is calculated thereby. The second determiner 14 determines the work intensity of the individual task based on the difference.

The output part 15 may calculate a score of the evaluation of the layout based on the movement path, the movement frequency, and the biological data. For example, the output part 15 performs time integration of the score of the biological data for each movement path. The output part 15 calculates an evaluation of the layout by comparing the obtained score to multiple preset thresholds. An evaluation value of the evaluation of the layout may be calculated. For example, the time integral of the score is output as the evaluation value. Or, the calculated time integral may be normalized using an evaluation value related to a previous layout. The normalized value is output as the evaluation value.

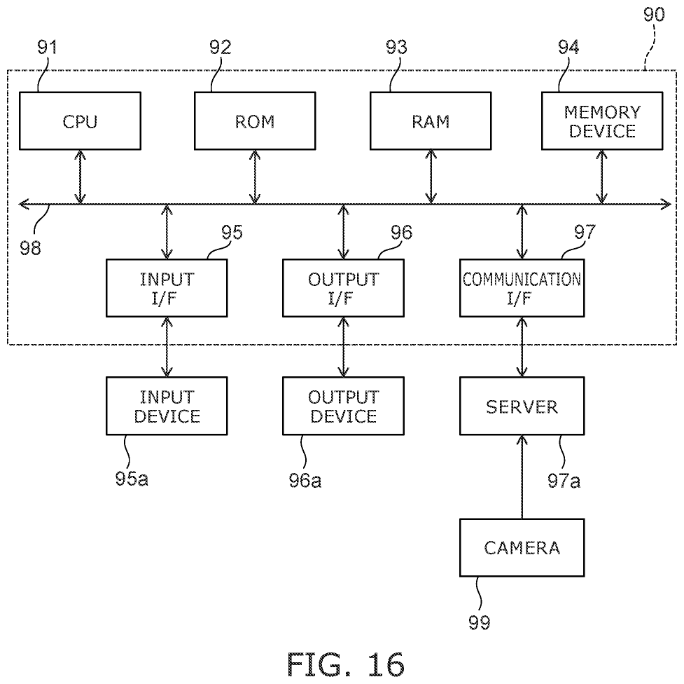

FIG. 16 is a schematic view showing a hardware configuration.

The processing device 10 includes, for example, the hardware configuration shown in FIG. 16. A computer 90 shown in FIG. 16 includes a CPU 91, ROM 92, RAM 93, a memory device 94, an input interface 95, an output interface 96, and a communication interface 97.

The ROM 92 stores programs that control the operations of a computer. Programs that are necessary for causing the computer to realize the processing described above are stored in the ROM 92. The RAM 93 functions as a memory region into which the programs stored in the ROM 92 are loaded.

The CPU 91 includes a processing circuit. The CPU 91 uses the RAM 93 as work memory to execute the programs stored in at least one of the ROM 92 or the memory device 94. When executing the programs, the CPU 91 executes various processing by controlling configurations via a system bus 98.

The memory device 94 stores data necessary for executing the programs and/or data obtained by executing the programs.

The input interface (I/F) 95 connects the computer 90 and an input device 95a. The input I/F 95 is, for example, a serial bus interface such as USB, etc. The CPU 91 can read various data from the input device 95a via the input I/F 95.

The output interface (I/F) 96 connects the computer 90 and an output device 96a. The output I/F 96 is, for example, an image output interface such as Digital Visual Interface (DVI), High-Definition Multimedia Interface (HDMI (registered trademark)), etc. The CPU 91 can transmit the data to the output device 96a via the output I/F 96 and cause the output device 96a to display an image.

The communication interface (I/F) 97 connects the computer 90 and a server 97a that is outside the computer 90. The communication I/F 97 is, for example, a network card such as a LAN card, etc. The CPU 91 can read various data from the server 97a via the communication I/F 97. A camera 99 images articles and stores the images in the server 97a.

The memory device 94 includes at least one selected from a hard disk drive (HDD) and a solid state drive (SSD). The input device 95a includes at least one selected from a mouse, a keyboard, a microphone (audio input), and a touchpad. The output device 96a includes at least one selected from a monitor and a projector. A device such as a touch panel that functions as both the input device 95a and the output device 96a may be used.

The memory device 94 may function as the memory device 30. The input device 95a may function as the input device 31. The output device 96a may function as the output device 32. The camera 99 may function as the imaging device 20.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD±R, DVD±RW, etc.), semiconductor memory, or a recording medium (a non-transitory computer-readable storage medium) that can be read by another nontemporary computer.

For example, information that is recorded in the recording medium can be read by a computer (or an embedded system). The recording format (the storage format) of the recording medium is arbitrary. For example, the computer reads the program from the recording medium and causes the CPU to execute the instructions recited in the program based on the program. In the computer, the acquisition (or the reading) of the program may be performed via a network.

According to embodiments described above, an analysis system and an analysis method are provided in which a task can be analyzed from the perspective of efficiency and safety. Similar effects can be obtained by causing a computer to execute the analysis method described above.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions. Embodiments described above can be implemented in combination with each other.

What is claimed is:

1. An analysis system, comprising:
a detector detecting a worker in an image of a work site and calculating a position of the worker;
a first determiner referring to layout data related to a layout of a plurality of work areas in the work site and determining a movement path of the worker in the layout based on the calculated position;
a second determiner determining a work intensity of the worker from biological data of the worker; and
an output part outputting an analysis result,
the analysis result being of the layout, the movement path between the plurality of work areas, a movement frequency of the movement path, and the work intensity of the movement path.

2. The analysis system according to claim 1, wherein
the layout data includes an image of the layout, an origin coordinate, an axis direction, a coordinate of each of the plurality of work areas, and a path between the plurality of work areas.

3. The analysis system according to claim 1, further comprising:
an acquisition part acquiring the images obtained by imaging the plurality of work areas and the paths between the plurality of work areas.

4. The analysis system according to claim 1, wherein
the detector calculates the position of the worker in each of a plurality of the images and converts each of the positions into a position in a common coordinate system of the layout, and
the first determiner determines the movement path by using the positions in the common coordinate system.

5. The analysis system according to claim 4, wherein
the detector calculates a certainty of the position for each of at least two of the images imaged at a same time when a same worker is visible in the at least two of the images, and
the detector combines at least two of the positions into one position by using at least two of the certainties.

6. The analysis system according to claim 1, wherein
the detector calculates positions of a plurality of the workers from a plurality of the images and identifies each of the plurality of workers,
the first determiner determines the movement path of each of the plurality of workers, and
the second determiner determines the work intensity of each of the plurality of workers from a plurality of the biological data of the plurality of workers.

7. The analysis system according to claim 6, wherein
the analysis result includes:
an overall analysis result related to the plurality of workers, the overall analysis result being of a plurality of the movement paths, the movement frequency, and a plurality of the work intensities; and
an individual analysis result related to one of the plurality of workers, the individual analysis result being of at least one of the plurality of movement paths, the movement frequency of the at least one of the plurality of movement paths, and at least one of the plurality of work intensities.

8. The analysis system according to claim 1, wherein
the output part calculates an evaluation of the layout based on the movement path, the movement frequency, and the biological data.

9. The analysis system according to claim 1, wherein
the second determiner calculates the work intensity of the movement path by using a difference between the biological data obtained for movement between the plurality of work areas and the biological data other than the biological data obtained for the movement.

10. An analysis method causing a computer to:
detect a worker in an image of a work site;
calculate a position of the worker in the image;
refer to layout data related to a layout of a plurality of work areas in the work site;
determine a movement path of the worker in the layout based on the calculated position;
determine a work intensity of the worker from biological data of the worker; and
output an analysis result,
the analysis result being of the layout, the movement path between the plurality of work areas, a movement frequency of the movement path, and the work intensity of the movement path.

11. A storage medium storing a program,
the program causing a computer to:
detect a worker in an image of a work site;
calculate a position of the worker in the image;
refer to layout data related to a layout of a plurality of work areas in the work site;
determine a movement path of the worker in the layout based on the calculated position;
determine a work intensity of the worker from biological data of the worker; and
output an analysis result,
the analysis result being of the layout, the movement path between the plurality of work areas, a movement frequency of the movement path, and the work intensity of the movement path.
